(19) United States
(12) Patent Application Publication
(10) Pub. No.: US 2025/0199947 A1
(43) Pub. Date: Jun. 19, 2025

(54) SYMBOLIC EXECUTION-BASED SOFTWARE TESTING APPARATUS AND METHOD

(71) Applicant: Research & Business Foundation Sungkyunkwan University, Suwon-si (KR)

(72) Inventors: Sooyoung CHA, Suwon-si (KR); Jaehan YOON, Suwon-si (KR)

(73) Assignee: Research & Business Foundation Sungkyunkwan University, Suwon-si (KR)

(21) Appl. No.: 18/975,230

(22) Filed: Dec. 10, 2024

(30) Foreign Application Priority Data
Dec. 15, 2023 (KR) 10-2023-0182582

(51) Int. Cl. G06F 11/3698; G06F 11/3668

(52) U.S. Cl. CPC G06F 11/3698; G06F 11/3688; G06F 11/3692

(57) ABSTRACT

The present invention relates to a symbolic execution-based software testing apparatus, according to one embodiment, the software testing apparatus comprises an information collector configured to generate a path by repeatedly performing symbolic execution, and collect branch conditional statements and path conditional expressions searched for generating the path, a group generator configured to group the path conditional expression based on the branch conditional statement included in the path conditional expression to generate a cluster and a state feature selector configured to select the branch conditional statement to be used as the state feature from the cluster according to a preset criterion, and convert the path into a feature vector using the state feature.

### CROSS-REFERENCE TO RELATED APPLICATIONS

This application claims the priority benefit of Korean Patent Application No. 10-2023-0182582 filed on Dec. 15, 2023, in the Korean Intellectual Property Office, the disclosures of which are incorporated herein by reference.

### BACKGROUND

### 1. Field

The present invention relates to a software testing apparatus and method.

### 2. Description of the Related Art

Symbolic execution is one representative software testing technique that performs a test by replacing an input of software with a symbolic variable.

Symbolic execution executes software and manages the searched path in the form of a state, and branches (forks) each time a conditional statement is met, increasing the number of states. Accordingly, the symbolic execution method may cause a state-explosion problem in which the number of entire states exponentially increases as execution continues. For this reason, an appropriate state selection strategy is required for effective symbolic execution.

A key component of a state selection strategy includes a state feature that expresses specific information of a state and a ranking function for determining a priority between states. Existing studies have suggested ways to define both factors according to the intuition of experts, or to automatically generate ranking functions using machine learning techniques. However, even in various studies, there is still a problem that many state features should be made at a large cost depending on the intuition or knowledge of experts.

### SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

The present invention provides a software testing apparatus and method for determining a state selection strategy by determining a state feature and a ranking function in symbolic execution based on a branch conditional statement and a path conditional expression.

The present invention relates to a symbolic execution-based software testing apparatus, according to one embodiment, the software testing apparatus comprises an information collector configured to generate a path by repeatedly performing symbolic execution, and collect branch conditional statements and path conditional expressions searched for generating the path, a group generator configured to group the path conditional expression based on the branch conditional statement included in the path conditional expression to generate a cluster and a state feature selector configured to select the branch conditional statement to be used as the state feature from the cluster according to a preset criterion, and convert the path into a feature vector using the state feature.

The state feature selector selects at least one cluster among the clusters, and selects a branch conditional statement, which is a basis of the selected cluster, as the branch conditional statement to be used as the state feature.

The state feature selector selects the at least one clusters so that all of the searched branch conditional statements are included in the entire path conditional expression included in the selected cluster.

The state feature selector selects a minimum number of clusters as possible when selecting the at least one cluster software testing apparatus.

The state feature selector selects the minimum number of clusters using a greedy method in a set cover problem.

The software testing apparatus further comprises a ranking function generator configured to use, as a ranking function, a value obtained by calculating a weight vector to the feature vector.

The ranking function generator may use, as the ranking function, a value calculated by adding a preset value as a weight value in the weight vector, divide the weight value into a plurality of groups based on a software testing result according to the ranking function, and determine the weight based on the similarity of weight distribution between the plurality of groups.

The ranking function generator calculates the weight distribution similarity between the group having the highest average of the testing result values and the group having the lowest average of the testing result values among the groups obtained by dividing the weight values, and determines the weight value from the group having the highest average when the similarity is equal to or less than a preset criterion.

The weight distribution similarity is calculated based on an average and a standard deviation of weights in the group.

The present invention relates to a symbolic execution-based software testing method using a state feature, according to another embodiment, software testing method comprises generating a path by repeatedly performing symbolic execution and collecting branch conditional statements and path conditional expressions searched for generating path by an information collector, generating a cluster by grouping the path conditional expressions based on the branch conditional statements included in the path conditional expressions by a group generator and selecting the branch conditional statements to be used as the state feature from the cluster according to a preset criterion and converting the path into a feature vector using the state feature by a state feature selector.

The selecting the branch conditional statements is configured to select at least one cluster among the clusters, and selects a branch conditional statement, which is a basis of the selected cluster, as the branch conditional statement to be used as the state feature.

The selecting the branch conditional statements is configured to select the at least one clusters so that all of the searched branch conditional statements are included in the entire path conditional expression included in the selected cluster.

The selecting the branch conditional statements is configured to select a minimum number of clusters as possible when selecting the at least one cluster software testing apparatus.

The selecting the branch conditional statements is configured to select the minimum number of clusters using a greedy method in a set cover problem.

The software testing method further comprises using, as a ranking function, a value obtained by calculating a weight vector to the feature vector by a ranking function generator.

The using, as a ranking function, a value obtained by calculating a weight vector to the feature vector is configured to use, as the ranking function, a value calculated by adding a preset value as a weight value in the weight vector, divide the weight value into a plurality of groups based on a software testing result according to the ranking function, and determine the weight based on the similarity of weight distribution between the plurality of groups.

The using, as a ranking function, a value obtained by calculating a weight vector to the feature vector is configured to calculates the weight distribution similarity between the group having the highest average of the testing result values and the group having the lowest average of the testing result values among the groups obtained by dividing the weight values, and determines the weight value from the group having the highest average when the similarity is equal to or less than a preset criterion.

The weight distribution similarity is calculated based on an average and a standard deviation of weights in the group.

According to the above-described symbolic execution-based software testing apparatus and method, costs for designing a state selection strategy may be significantly reduced by determining a state feature and a ranking function based on a branch conditional statement and a path conditional expression, and software error detection capability may be improved.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram of a software testing apparatus according to an embodiment.

FIG. 2 is a schematic diagram illustrating a process of performing symbolic execution according to an embodiment.

FIG. 3 is a schematic diagram showing that each path conditional expression is grouped according to an embodiment.

FIG. 4 is a schematic diagram showing a process of selecting a state feature according to an embodiment.

FIG. 5 is a schematic diagram showing a selected branch conditional statement and a state (path) accordingly as a state feature according to an embodiment.

FIG. 6 is a schematic diagram illustrating a process of calculating an operation result value according to an embodiment.

FIG. 7 is a diagram showing the result of a weight value corresponding to a state feature based on a testing result according to an embodiment.

FIG. 8 is a schematic diagram showing the software testing apparatus and the symbolic execution apparatus according to an embodiment.

FIG. 9 is a flowchart of a software testing method according to an embodiment.

Throughout the drawings and the detailed description, the same reference numerals may refer to the same, or like, elements. The drawings may not be to scale, and the relative size, proportions, and depiction of elements in the drawings may be exaggerated for clarity, illustration, and convenience.

### DETAILED DESCRIPTION

The advantages and features of the present invention, and the methods for achieving them, will become apparent with reference to the embodiments described below in conjunction with the accompanying drawings. However, the present invention is not limited to the embodiments disclosed herein and may be implemented in various forms. These embodiments are provided merely to ensure the completeness of the disclosure of the present invention and to fully inform those skilled in the art of the scope of the invention. The invention is only defined by the scope of the claims.

Terms used in this specification will be briefly described, followed by a detailed description of the present invention.

The terms used in the present invention have been selected, where possible, as generally accepted terms currently in widespread use, taking into account the functions of the present invention. However, such terms may vary depending on the intent of the technician in the field, precedents, or the emergence of new technology. Additionally, in certain cases, terms arbitrarily chosen by the applicant may be used, in which case their meanings will be described in detail in the relevant parts of the specification. Therefore, the terms used in this invention should not be interpreted based solely on their names but should be defined based on their meanings and the overall context of the present invention.

Throughout the specification, when a part is described as “including” a specific component, it is to be understood that, unless otherwise stated, it does not exclude other components but may further include additional components. Additionally, terms such as “unit,” “module,” and “component” as used herein refer to units for processing at least one function or operation, and they may be implemented by software, hardware components such as FPGAs or ASICs, or a combination of software and hardware. However, the terms “unit,” “module,” and “component” are not limited to software or hardware. These terms may be configured to be stored on addressable storage media or to execute one or more processors. For example, “unit,” “module,” and “component” may refer to software components, object-oriented software components, class components, and task components, as well as components such as processes, functions, attributes, procedures, subroutines, program code segments, drivers, firmware, microcode, circuits, data, databases, data structures, tables, arrays, and variables.

Hereinafter, the embodiments of the present invention will be described in detail with reference to the accompanying drawings so that those skilled in the art may easily practice the invention. In the drawings, portions unrelated to the explanation of the invention may be omitted for clarity.

Terms such as “first” and “second,” which include ordinal numbers, may be used to describe various components but do not limit the components by the terms. The terms are used solely for distinguishing one component from another. For example, within the scope of the present invention, a “first” component may be referred to as a “second” component, and similarly, a “second” component may be referred to as a “first” component. The term “and/or” includes combinations of multiple related items or any one of the multiple related items.

Hereinafter, a software testing apparatus 1 and method of the present invention will be described with reference to the drawings.

The software testing apparatus 1 and method of the present invention are a testing apparatus and method based on symbolic execution. Symbolic execution manages the searched path in the form of a state, branches every time a conditional statement is encountered, and requires an appropriate state selection strategy because the total number of states increases. The state selection strategy includes a state feature representing specific information of candidate states and a ranking function for determining priorities of the candidate states. The present invention is for a proper state selection strategy in symbolic execution, and is characterized in determining a state selection strategy by determining a state feature and a ranking function selection based on a branch conditional statement and a path conditional expression.

The present invention relates to a software testing apparatus 1 and a method, which are related to a symbolic execution-based software testing apparatus 1 using a state feature, capable of generating a path by repeatedly performing symbolic execution, and collecting branch conditional statements and path conditional expressions searched for path generation. In addition, the software testing apparatus 1 and the method may generate the cluster by grouping the path conditional expressions based on the branch conditional expressions included in the path conditional expressions. In addition, the software testing apparatus 1 and method may select a branch conditional statement to be used as a state feature from the cluster according to a preset criterion, and convert the path into a feature vector using the state feature.

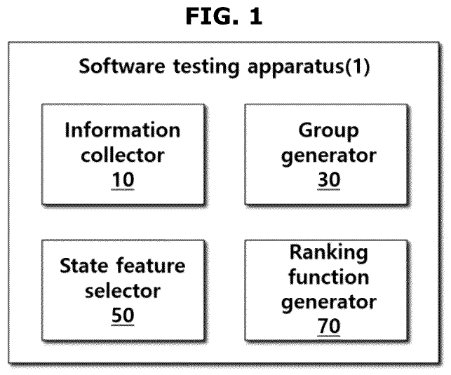

FIG. 1 is a block diagram of a software testing apparatus 1 according to an exemplary embodiment of the present invention.

The software testing apparatus 1 of the present invention may be provided in a form that is additionally included in an existing commercial software testing tool (e.g., Microsoft SAGE, etc.), or may be provided by being implemented as a separate apparatus.

The software testing apparatus 1 of the present invention may be provided as a processor apparatus to perform software testing therethrough. That is, each component (module, etc.) included in the software testing apparatus 1 may perform the function of the corresponding component through the processor apparatus. The processor may include one or more of a Central Processing Unit (CPU), a Graphic Processing Unit (GPU), a Micro Controller Unit (MCU), an Application Processor (AP), an Electronic Controlling Unit (ECU), a Micro Processor (Micom), or at least one electronic apparatus capable of performing various other operations and control processing. These processing or control apparatus may be implemented, for example, by using one or two or more semiconductor chips, circuits, or related components alone or in combination. However, the disclosure is not limited thereto, and may be implemented by various apparatus capable of processing information.

In addition, the software testing apparatus 1 may be additionally implemented by separately providing a collection apparatus for collecting information, a storage apparatus for storing collected information and products (result values, etc.) processed and derived by the processor, and an output apparatus for outputting these information.

For example, the software testing apparatus 1 may include an input apparatus, such as a keyboard, a mouse, or a touch pad, which may receive a user's input, and a communication apparatus, which may communicate with other apparatus or components, as the collection apparatus, and may collect the user's input, communication signals, and the like received through the input apparatus and the communication apparatus. Also, for example, the software testing apparatus 1 may include at least one of a main memory apparatus and an auxiliary memory apparatus as a storage apparatus. The main memory apparatus may be implemented using a semiconductor storage medium such as, for example, ROM and/or RAM, and the auxiliary memory apparatus may be implemented based on an apparatus capable of permanently or semi-permanently storing data, such as a flash memory apparatus (a Solid State Drive (SSD)), a Secure Digital (SD) card, a Hard Disc Drive (HDD), a compact disk, a Digital Versatile Disk (DVD), a laser disk, or the like. In addition, for example, the software testing apparatus 1 may include a display, a printer apparatus, a speaker apparatus, an image output terminal, a data input/output terminal, and the like as an output apparatus, and may output an intermediate product or a value according to the result according to the software testing process to the user or transmit the intermediate product or the value to another apparatus or configuration. However, the collection apparatus, the storage apparatus, and the output apparatus of the software testing apparatus 1 are not limited to the above-described examples, and apparatus suitable for performing the corresponding functions may be used without limitation.

Referring to FIG. 1, the software testing apparatus 1 according to an embodiment of the present invention may include an information collector 10, a group generator 30, a state feature selector 50, and a ranking function generator 70.

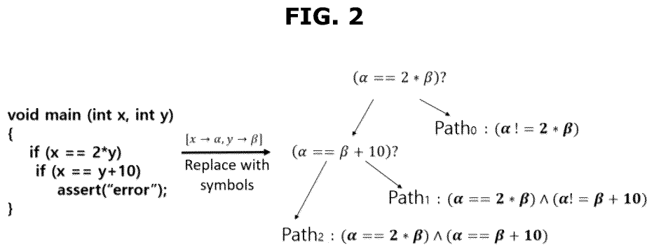

The information collector 10 will be described with reference to FIG. 2.

The information collector 10 may generate a path (state) by repeatedly performing symbolic execution, and collect branch conditional statements and path conditional expressions searched for path generation.

The information collector 10 may generate a path by repeatedly performing symbolic execution. According to an embodiment, the information collector 10 may generate a path by repeatedly performing symbolic execution. Here, the path may be a test case generated through a branch conditional statement. That is, the information collector 10 may repeatedly execute symbolic execution for a predetermined time to generate various paths as test cases through a preset branch conditional statement. For example, the information collector 10 may generate a plurality of paths as a test case by repeating symbolic execution 20 times for a short time of 120 seconds. FIG. 2 is a schematic diagram illustrating a process of performing symbolic execution according to an embodiment. Referring to FIG. 2, it can be seen that the information collector 10 may generate various paths through each branch conditional statement through symbolic execution.

The information collector 10 may collect branch conditional statements and path conditional expressions searched for path generation. The information collector 10 passes through a branch conditional statement in generating each path, and each path may have information on the last branch conditional statement as a path conditional expression in order to generate the corresponding path. Referring back to FIG. 2, the branch conditional statements traversed to generate a path are (α==2*β)?((α==2*β) and (α!=2*β)), (α==β+10)?((α==β+10) and (α!=β+10), and each path may have a path conditional expression of (α!=2*β), (α==2*β)Λ(α!=β+10), (α==2*β)Λ(α==β+10) as the branch statement traversed to generate the corresponding path. Therefore, the information collector 10 may collect all branch conditional statements explored while generating test cases, as well as the path conditional expressions for each test case.

According to an embodiment, the information collector 10 may perform symbolic execution through a separate apparatus. In this case, the information collector 10 may repeatedly perform symbolic execution through commands to a separate apparatus for symbolic execution, and collect branch conditional statements and path conditional expressions generated through the symbolic execution.

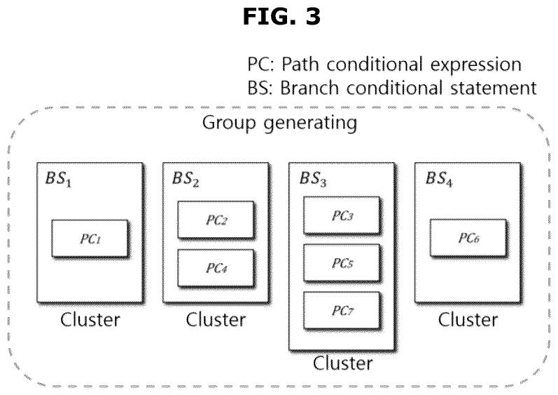

The group generator 30 will be described with reference to FIG. 3.

The group generator 30 may generate a cluster by grouping the path conditional expression based on the branch conditional statement included in the path conditional expression.

The group generator 30 may receive information of path conditional expressions and branch conditional statements included therein from the information collector 10.

The group generator 30 may generate a cluster by grouping the path conditional expression based on the branch conditional statement included in the corresponding path conditional expression. That is, the group generator 30 may mean that each state (path) can be grouped based on the branch conditional statements traversed to pass through the corresponding path

According to an embodiment, the group generator 30 may group the path conditional expressions based on a branch conditional statement included at the last on the path among the branch conditional statements included in the path conditional expression. Each path conditional expression traverses multiple branch conditional statements in sequence, so each branch conditional statement may have an order of traversal. For example, referring to FIG. 2, since the path 2 has passed through (α==2*β) and then (α==β+10), the branch conditional statement included at the end of the path is (α==β+10)

According to an embodiment, the group generator 30 may group the path conditional expressions based on a set of covered branches reached by the path conditional expression. According to another embodiment, the group generator 30 may group the path conditional expression based on a set of covered paths that have reached.

The criterion used for the group generator 30 to group the path conditional expressions is not limited to the above-described embodiment, and each path conditional expression may be grouped by various criteria.

FIG. 3 is a schematic diagram showing that each path conditional expression is grouped based on a branch conditional statement in the group generator 30.

Referring to FIG. 3, it can be seen that each path conditional expression is grouped based on a branch conditional statement included in the respective path conditional expression, and clusters are formed accordingly. For example, the path conditional expression PC1 may be grouped based on the branch conditional statement BS1 included in the path conditional expression PC1, and the path conditional expressions PC2 and PC4 may be grouped based on the branch conditional statement BS2 included in the path conditional expressions PC2 and PC4. Each grouped set of path conditional expressions may be generated as a cluster (e.g., BS1, BS2).

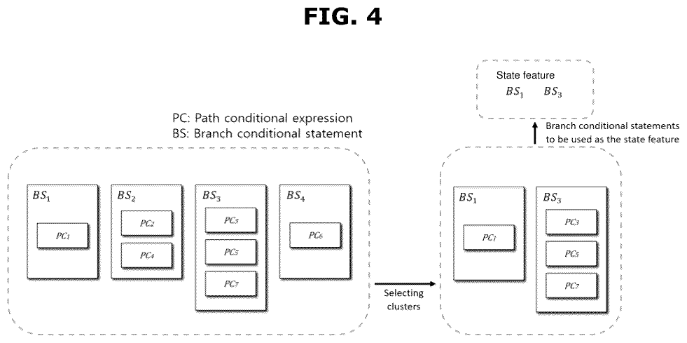

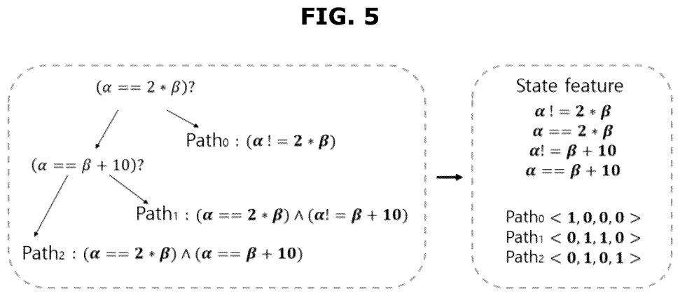

The state feature selector 50 will be described with reference to FIGS. 4 and 5.

The state feature selector 50 may select a branch conditional statement to be used as a state feature from the cluster according to a preset criterion, and convert a path into a feature vector using the state feature.

The state feature selector 50 may select a branch conditional statement to be used as the state feature from each cluster grouped in the group generator 30 described above according to a preset criterion. That is, the software testing apparatus 1 of the present invention may use the branch conditional statement as the state feature.

According to an embodiment, the state feature selector 50 may select at least one cluster among the clusters and determine the branch conditional statement forming the basis of the selected cluster as the branch conditional statement to be used as a state feature.

In addition, according to an embodiment, the state feature selector 50 may select at least one cluster so that all the found entire branch conditional statements may be included in the entire path conditional expression included in the selected cluster. The state feature selector 50 selects at least one or more clusters from among the plurality of clusters grouped above, and may select some clusters that may cover all the branch conditional statements in which the branch conditional statements included in the path conditional expression belonging to the corresponding some clusters are searched. That is, the state feature selector 50 may select at least one or more clusters so that all the previously searched branch conditional statements may be included in at least one or more path conditional expressions included in the selected corresponding some clusters. Referring back to the example of FIG. 2, when selecting some clusters, the state feature selector 50 may select some clusters in which each of the branch conditional statements of (α!=2*β)(α==2*β)(α!=β+10)(α==β+10) is included in at least one path conditional expression included in some selected clusters. In addition, a branch conditional statement, which is the basis of the selected clusters, may be selected as a branch conditional statement to be used as a state feature. FIG. 4 is a schematic diagram showing a process of selecting a state feature. For example, referring to FIG. 4, when all the branch conditional statements detected by the branch conditional statements included in the path conditional expressions PC1, PC3, PC5, and PC7 are able to be covered (that is, when the corresponding path conditional expression is viewed as a whole, at least one branch conditional statement previously detected is included), the BS1 and BS3 clusters may be selected, and the branch conditional statements BS1 and BS3 that are the basis of these clusters may be selected as the branch conditional statements to be used as the state feature.

In addition, according to an embodiment, in selecting at least one cluster, the state feature selector 50 may select a minimum number of clusters that may cover all of the found branch conditional statements. As described above, when the state feature selector 50 selects at least one cluster capable of covering all of the searched entire path conditional expressions, the number of various cases of selecting the cluster may occur. According to an embodiment, in this case, the state feature selector 50 may select clusters so that the number of selected clusters among the number of various cases is minimized. Referring back to the example of FIG. 4, there may be various cases of selecting clusters capable of covering all of the searched entire path conditional expressions, such as (BS1, BS2, BS3), (BS1, BS3, BS4), and (BS1, BS3). In this case, the state feature selector 50 may select (BS1, BS3) so that the number of clusters is minimized.

According to an embodiment, when selecting the minimum number of clusters capable of covering all the found branch conditional statements, the state feature selector 50 may use a greedy method in a set cover problem. Since the process of selecting the minimum number of clusters covering all of the branch conditional statements is a set cover problem well known as an NP-complete problem, an answer (the minimum number of clusters) close to a correct answer may be obtained through a greedy method. For example, if a cluster set (the minimum number of clusters capable of covering the entire branch conditional statement) to be obtained is defined as RC, the minimum number of cluster sets RC can be obtained by repeating a process of adding one cluster having the largest number of branch statements that are not covered by RC until the clusters included in RC cover all branch conditional statements until a path conditional expression in the cluster included in RC includes all branch conditional statements.

The state feature selector 50 may convert the path into a feature vector using the state feature. The state feature selector 50 may select a branch conditional statement to be used as a state feature through the above-described process, and may convert the previously generated paths into a feature vector by using the selected branch conditional statement as a state feature.

FIG. 5 is a schematic diagram showing a selected branch conditional statement and a state (path) accordingly as a state feature according to an embodiment. Referring to the embodiment of FIG. 5, through the above-described process, (α!=2*β)(α==2*β)(α!=β+10)(α==β+10) have been selected as branch conditional statements to be used as state features, and the state feature selector 50 may convert each path into a four-dimensional feature vector through this. The path 0 is only (α!=2*β) and thus may be represented by <1,0,0,0>, the path 1 is (α==2*β)Λ(α!=β+10) and thus may be represented by <0,1,1,0>, and the path 2 is (α==2*β) A (α==β+10) and thus may be represented by <0,1,0,1>.

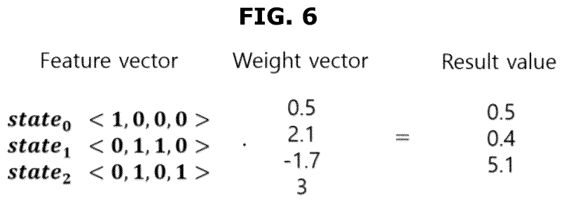

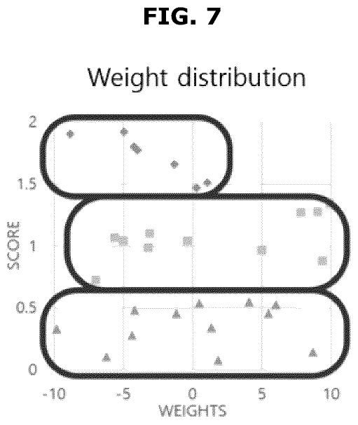

The ranking function generator 70 will be described with reference to FIGS. 6 and 7.

The ranking function generator 70 may use, as a ranking function, a value obtained by performing an operation on a feature vector and a weight vector.

The ranking function generator 70 may calculate a value obtained by calculating a weight vector for the feature vector generated by the above-described state feature selector 50 and use the calculated value as a ranking function. Specifically, the ranking function generator 70 may calculate a weight vector for a value obtained by converting each path into a feature vector through a state feature, calculate a result value according to each path, and use the result value as a ranking function.

FIG. 6 is a schematic diagram illustrating a process of calculating an operation result value in the ranking function generator 70. Referring to the example of FIG. 6, it can be seen that a result value is calculated for each path by computing a weight vector on a feature vector in which each path is converted through a state feature. The operation of the feature vector and the weight vector may be performed by multiplying the state feature included in each vector and each weight value corresponding thereto and adding the multiplied values. According to an example, in the case of path 0, a weight vector (0.5, 2.1, −1.7, 3) is calculated on the feature vector of <1,0,0,0> to calculate 0.5, in the case of path 1, a weight vector (0.5, 2.1, −1.7, 3) is calculated on the feature vector of <0,1,1,0> to calculate 0.4, and in the case of path 2, a weight vector (0.5, 2.1, −1.7, 3) is calculated on the feature vector of <0,1,0,1> to calculate 5.1.

According to an embodiment, the ranking function generator 70 may use, as the ranking function, a value calculated by adding a preset value as a weight value in the weight vector, divide the weight value into a plurality of groups based on a software testing result according to the ranking function, and determine the weight based on the similarity of weight distribution between the plurality of groups. Here, the software testing result value may mean a score calculated using information that may be obtained by testing software. For example, the software testing result value may be a score according to a testing result calculated by using branch coverage obtained through the testing result.

According to an embodiment, the preset value put into the weight value may be an arbitrary random number within a range preset by the user.

The ranking function generator 70 may add a preset value to each weight value in the weight vector to calculate the value with the feature vector, and perform software testing using the value as a ranking function.

In addition, the ranking function generator 70 may divide the weight value corresponding to each state feature into a plurality of groups based on the score evaluated according to the software testing result. For example, the ranking function generator 70 may divide the software testing result score into a group having a first criterion or more, a group having a second criterion or more and less than the first criterion, a group having a second criterion or less, and the like. FIG. 7 is a diagram showing the result of a weight value corresponding to a state feature based on a testing result according to an embodiment. Referring to the example of FIG. 7, it can be seen that each weight value is divided into three groups based on a score according to a software testing result.

In addition, the ranking function generator 70 may determine a weight based on the divided weight distribution similarity between the plurality of groups. The ranking function generator 70 may analyze the divided distribution of the weights in the plurality of groups, and determine the weight based on the distribution similarity between the respective groups.

According to an embodiment, the weight distribution similarity may be calculated based on an average and a standard deviation of weights in a group. That is, an average value and a standard deviation of the weights in one group may be calculated, and a weight distribution similarity between the groups may be calculated based on a degree of similarity of the values.

According to an embodiment, the ranking function generator 70 may compare the weight distribution similarity between the group having the highest average of the testing result values and the group having the lowest average of the testing result values among the groups obtained by dividing the weight values, and determine the weight value from the group having the highest average when the distribution similarity is equal to or less than a preset criterion. For example, as illustrated in FIG. 7, when the weight value is divided into three groups for each score based on the software testing result, the ranking function generator 70 may calculate the weight distribution similarity of the group having the highest average of the scores and the group having the lowest average of the scores. In addition, when the calculated similarity is equal to or less than one criterion, the ranking function generator 70 may determine the weight value from the group having the highest average of the scores. In other words, the ranking function generator 70 may determine one of the weight values included in the group having the highest average score as the weight value of the corresponding state feature as a result of software testing. According to an embodiment, the ranking function generator 70 may determine a value closest to the average among the weight values included in the group having the highest score average as the weight value of the corresponding state feature.

According to an embodiment, the ranking function generator 70 may compare the weight distribution similarity between the group having the highest average of the testing result values and the group having the lowest average of the testing result values among the groups obtained by dividing the weight values, and randomly determine the weight value when the distribution similarity is equal to or greater than a preset criterion.

The software testing apparatus 1 of the present invention may determine the state feature and the ranking function through the above process.

The software testing apparatus 1 may apply a state selection strategy having a state feature and a ranking function determined by a branch conditional statement and a path conditional expression as constituent elements, and accordingly, may perform software testing by performing symbolic execution.

In addition, according to another embodiment, the software testing apparatus 1 of the present invention may be provided in a form in which it is added to another software testing apparatus 1 based on symbolic execution, and may be provided in a form in which a strategy for selecting a state in symbolic execution of the corresponding other apparatus is additionally performed. In this case, the symbolic execution performed in the present invention may be performed by using a method performed instead in the corresponding other apparatus.

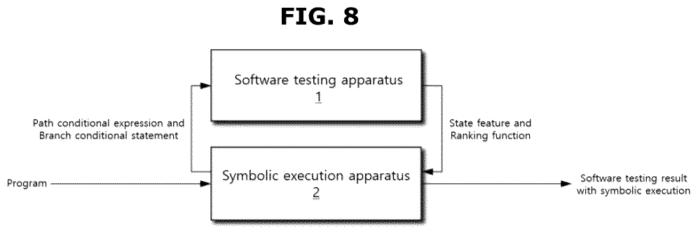

FIG. 8 is a schematic diagram showing the software testing apparatus 1 and the symbolic execution apparatus 2 of the present invention. Referring to FIG. 8, the software testing apparatus according to another embodiment of the present invention may provide a separate symbolic execution apparatus 2 for executing a symbol, so that the corresponding apparatus may execute the symbolic execution. Referring to FIG. 8, the symbolic execution apparatus 2 may receive a program and execute symbolic execution to search for a path, and accordingly, search for a path conditional expression and a branch conditional statement. The software testing apparatus 1 may receive the searched path conditional equation and branch conditional statement, determine the state feature and the ranking function through the above-described processes, and transmit the determined state feature and ranking function back to the symbolic execution apparatus 2. The symbolic execution apparatus 2 may perform the symbolic execution through a state selection strategy based on the received state feature and ranking function to perform software testing.

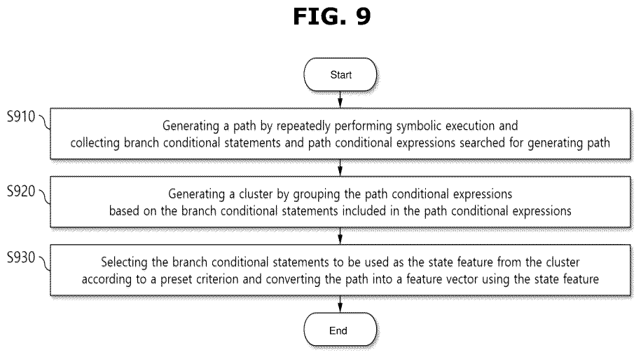

Hereinafter, a method for testing software based on symbolic execution of the present invention will be described with reference to FIG. 9.

FIG. 9 is a flowchart of a software testing method according to an exemplary embodiment of the present invention.

Referring to FIG. 9, the software testing method according to the present invention relates to a symbolic execution-based software testing method using state features and ranking functions, and comprises generating a path by repeatedly performing symbolic execution and collecting branch conditional statements and path conditional expressions searched for generating path by an information collector (S910), generating a cluster by grouping the path conditional expressions based on the branch conditional statements included in the path conditional expressions by a group generator (S920) and selecting the branch conditional statements to be used as the state feature from the cluster according to a preset criterion and converting the path into a feature vector using the state feature by a state feature selector (S930).

According to an embodiment, the selecting the branch conditional statements is configured to select at least one cluster among the clusters, and selects a branch conditional statement, which is a basis of the selected cluster, as the branch conditional statement to be used as the state feature.

According to an embodiment, the selecting the branch conditional statements is configured to select the at least one clusters so that all of the searched branch conditional statements are included in the entire path conditional expression included in the selected cluster.

According to an embodiment, the selecting the branch conditional statements is configured to select a minimum number of clusters as possible when selecting the at least one cluster software testing apparatus.

According to an embodiment, the selecting the branch conditional statements is configured to select the minimum number of clusters using a greedy method in a set cover problem.

According to an embodiment, the software testing method further comprises using, as a ranking function, a value obtained by calculating a weight vector to the feature vector by a ranking function generator.

According to an embodiment, the using, as a ranking function, a value obtained by calculating a weight vector to the feature vector is configured to use, as the ranking function, a value calculated by adding a preset value as a weight value in the weight vector, divide the weight value into a plurality of groups based on a software testing result according to the ranking function, and determine the weight based on the similarity of weight distribution between the plurality of groups.

According to an embodiment, the using, as a ranking function, a value obtained by calculating a weight vector to the feature vector is configured to calculates the weight distribution similarity between the group having the highest average of the testing result values and the group having the lowest average of the testing result values among the groups obtained by dividing the weight values, and determines the weight value from the group having the highest average when the similarity is equal to or less than a preset criterion.

According to an embodiment, the weight distribution similarity is calculated based on an average and a standard deviation of weights in the group.

Those skilled in the art to which the embodiments of the present invention pertain will understand that the invention can be implemented in modified forms without departing from the essential characteristics described above. Therefore, the disclosed methods should be considered from an explanatory perspective rather than a limiting one. The scope of the present invention is defined by the claims, not by the detailed description, and all differences within the equivalent scope are to be interpreted as included within the scope of the present invention.

What is claimed is:

1. A symbolic execution-based software testing apparatus using a state feature, the apparatus comprising:
an information collector configured to generate a path by repeatedly performing symbolic execution, and collect branch conditional statements and path conditional expressions searched for generating the path;
a group generator configured to group the path conditional expression based on the branch conditional statement included in the path conditional expression to generate a cluster; and
a state feature selector configured to select the branch conditional statement to be used as the state feature from the cluster according to a preset criterion, and convert the path into a feature vector using the state feature.

2. The software testing apparatus of claim 1, wherein the state feature selector selects at least one cluster among the clusters, and selects a branch conditional statement, which is a basis of the selected cluster, as the branch conditional statement to be used as the state feature.

3. The software testing apparatus of claim 2, wherein the state feature selector selects the at least one clusters so that all of the searched branch conditional statements are included in the entire path conditional expression included in the selected cluster.

4. The software testing apparatus of claim 3, wherein the state feature selector selects a minimum number of clusters as possible when selecting the at least one cluster software testing apparatus.

5. The software testing apparatus of claim 4, wherein the state feature selector selects the minimum number of clusters using a greedy method in a set cover problem.

6. The software testing apparatus of claim 1, further comprising:
a ranking function generator configured to use, as a ranking function, a value obtained by calculating a weight vector to the feature vector.

7. The software testing apparatus of claim 6, wherein the ranking function generator may use, as the ranking function, a value calculated by adding a preset value as a weight value in the weight vector, divide the weight value into a plurality of groups based on a software testing result according to the ranking function, and determine the weight based on the similarity of weight distribution between the plurality of groups.

8. The software testing apparatus of claim 7, wherein the ranking function generator calculates the weight distribution similarity between the group having the highest average of the testing result values and the group having the lowest average of the testing result values among the groups obtained by dividing the weight values, and determines the weight value from the group having the highest average when the similarity is equal to or less than a preset criterion.

9. The software testing apparatus of claim 7, wherein the weight distribution similarity is calculated based on an average and a standard deviation of weights in the group.

10. A symbolic execution-based software testing method using a state feature, the method comprising:
generating a path by repeatedly performing symbolic execution and collecting branch conditional statements and path conditional expressions searched for generating path by an information collector;
generating a cluster by grouping the path conditional expressions based on the branch conditional statements included in the path conditional expressions by a group generator; and
selecting the branch conditional statements to be used as the state feature from the cluster according to a preset criterion and converting the path into a feature vector using the state feature by a state feature selector.

11. The software testing method of claim 10, wherein the selecting the branch conditional statements is configured to select at least one cluster among the clusters, and selects a branch conditional statement, which is a basis of the selected cluster, as the branch conditional statement to be used as the state feature.

12. The software testing method of claim 11, wherein the selecting the branch conditional statements is configured to select the at least one clusters so that all of the searched branch conditional statements are included in the entire path conditional expression included in the selected cluster.

13. The software testing method of claim 12, wherein the selecting the branch conditional statements is configured to select a minimum number of clusters as possible when selecting the at least one cluster software testing apparatus.

14. The software testing method of claim 13, wherein the selecting the branch conditional statements is configured to select the minimum number of clusters using a greedy method in a set cover problem.

15. The software testing method of claim 10, further comprising:
using, as a ranking function, a value obtained by calculating a weight vector to the feature vector by a ranking function generator.

16. The software testing method of claim 15, wherein the using, as a ranking function, a value obtained by calculating a weight vector to the feature vector is configured to use, as the ranking function, a value calculated by adding a preset value as a weight value in the weight vector, divide the weight value into a plurality of groups based on a software testing result according to the ranking function, and determine the weight based on the similarity of weight distribution between the plurality of groups.

17. The software testing method of claim 16, wherein the using, as a ranking function, a value obtained by calculating a weight vector to the feature vector is configured to calculates the weight distribution similarity between the group having the highest average of the testing result values and the group having the lowest average of the testing result values among the groups obtained by dividing the weight values, and determines the weight value from the group having the highest average when the similarity is equal to or less than a preset criterion.

18. The software testing method of claim 16, wherein the weight distribution similarity is calculated based on an average and a standard deviation of weights in the group.
